(19) United States
(12) Patent Application Publication
(10) Pub. No.: US 2011/0001804 A1
(43) Pub. Date: Jan. 6, 2011

(54) Apparatus for Displaying 3D Images

(75) Inventors: Hakan Urey, Istanbul (TR); Murat Sayinta, Istanbul (TR)

Correspondence Address: MICROVISION, INC., 6222 185TH AVENUE NE, REDMOND, WA, 98052, US

(73) Assignees: MICROVISION, INC., Redmond, WA (US); KOC UNIVERSITESI, Istanbul (TR)

(21) Appl. No.: 12/866,005

(22) PCT Filed: May 6, 2008
(86) PCT No.: PCT/IB08/01140

§ 371 Date: Aug. 3, 2010

(51) Int. Cl. H04N 13/04

(52) U.S. Cl. 348/51; 348/E13.026

(57) ABSTRACT

A 3D visualization apparatus is described based on the method of generating different horizontal light emitting directions from different screen positions. This is achieved by way of an array of scanning light source modules placed behind the screen. The scanning modules can be implemented by using an array of ID or 2D scanning modules where each one is coupled with at least one light source.

### TECHNICAL FIELD

The present invention relates generally to an apparatus that enables 3D displaying.

### BACKGROUND OF THE INVENTION

Today's developed displays with advanced technologies including “Liquid Crystal Display (LCD)” show images with very high quality. However, there is a vital inadequacy with today's 2D displays. This inadequacy is a result of expressing the 3D real world on a 2D plane and ignoring the fact that human beings experience the real world through two different eyes. In vision of the real world, two eyes correspond to two different views for the visual system while traditional displays provide only one view to the visual system—the same view towards each eye. 3D Displays seem to be the next step in the evolution of displays and will overcome this inadequacy by providing different views to different eyes. With the incredible developments in the digital video processing and visualizing technologies, first commercial 3D display products are already available in the market. It is helpful to classify 3D displays for a better understanding of their development trend and a possible classification can be as holographic displays, volumetric displays and auto-stereoscopic displays [1].

First group, holographic displays in spite of their great potential stemming from their 3D reconstruction quality, are not strong candidates for being widespread and commercial in the following years, due to high bandwidth requirements, demand for SLMs with high resolution and difficulties in achieving natural shading. Second group, volumetric displays have a variety of approaches e.g. real image methods applying static or moving displays and few commercial products realizing these approaches. Perspecta developed by Actuality Systems having a rotating disc at 900 rpm on which images are projected sequentially is a good example for real image approaches with a moving display. Fogscreen, creating an image on fog-like particles which seems to be floating in the air is a good example for real image approaches with static displays. The volumetric displays have the vital drawback of transparency. It means that objects that should be behind some other objects, are not occluded by the front object and seen by the viewer which cause a confliction in viewer's 3D perception. Another drawback with volumetric displays is their incapability of displaying surfaces having non-Lambertian intensity distributions. Today, the third group, auto stereoscopic multi-view displays e.g. Philips' multi-view display using slanted lenticular sheet or Sanyo's multi-view display using parallax barrier, seem to have the highest potential of acceptance in the display market in the following years. However, auto stereoscopic displays have also their own drawbacks including: generation of pseudoscopic viewing regions, decrease in resolution with increasing view number, discontinuities and jumps between adjacent views, eye fatigue stemming from accordance problem of accommodation and vergence mechanisms of the eye.

Holographic-like displays solve some major problems of the auto stereoscopic displays mentioned above and provide the key advantages of holographic displays such as accommodation-vergence synchronization and smoother motion parallax by constituting larger number of views in the field of view [1], [2]. Actually, it is found that twenty views per interocular distance is an optimum value for smooth motion parallax. There are a few examples of holographic-like displays that use micro display array and collimated light source [3], [4], a laser or array of laser diodes and 2D scanners [5], [6].

U.S. Pat. No. 6,999,071 issued in February 2006 explains such a 3D Display method. The 3D display D_{3D} tries to realize a 2D Screen 20 with screen pixels S that can emit light with different colors and intensities to different directions L_{S1} to L_{Sn}[3]-[6]. The system transmits independently modulated light beams L_{M} in different directions L_{S1} to L_{Sn} from a single screen point S in contrast to traditional 2D displays D_{2D} transmitting the same light information in every direction from a single screen point S as illustrated in FIG. 1.

This is accomplished by illuminating numerous 2D micro displays 60 controlled according to the 3D image that will be displayed. The light from the light source 13 is collimated before illuminating the micro displays 60. Each independently modulated light beam L_{M} by the individual pixels S of the 2D micro displays is then transmitted in different directions by a lens system 31 and 32 present in front of each 2D micro display 60, as shown in FIG. 2. By the help of screen 20, the independently modulated light beams L_{M} are asymmetrically diffused to the viewing zone. One of the most important advantages of such a system is its capability to be produced by integrating identical sub blocks (modules) M side by side in a modular fashion. The 3D display volumetric size is scalable in a way similar to LEGO™ blocks.

FIG. 3 illustrates how the 3D display concept D_{3D} realizes 3D viewing and how different viewers with different perspective perceive different images. In the figure, there are two different viewers V₁, V₂ and 4 objects points O₁, O₂, O₃, O₄ that are imaged behind or in front of elliptically diffusing screen 20 by different modules M. The modules M constitute an array in horizontal direction. Every module M in this array is capable of emitting independently modulated light beams L_{M} to pre-defined directions. The first viewer V₁ can see object O₁, O₂ and O₄ clearly as his both eyes E_{1R} and E_{1L} receive ray bundles from the objects O₁, O₂ and O₄. However, only his left eye E_{1L} receives light from O₃. By this way the first viewer V₁ understands that object O₃ is occluded by the object O₁. The second viewer V₂ cannot see the object O₁ as it in not in his field of view. He can see the object O₃ and O₄ clearly but only his right eye E_{2R} receives light from object O₂ so that he understands that object O₂ is occluded by object O₃.

### SUMMARY OF THE INVENTION

In this invention, the above 3D visualization concept, approaching 3D displays as 2D displays that have pixels emitting different color and intensity light to different directions, is realized by using an array of scanners that images properly modulated light to the proper screen pixels on their scanning path.

In a preferred embodiment of the system, 1D array of light sources per each main color are integrated with 1D modules scanning in torsion mode together with imaging lenses. The light sources are modulated by a driving circuitry which is mounted ON or OFF the scanning platform. There is 2D array of these scanning modules behind the screen placed with a specific periodicity to a specific distance according to the resolution requirements of the display and the number of different views the display requires to provide. The precisely controlled intersections of rays coming from several scanning modules correspond to a complete set of voxels and the viewers looking from different perspectives will see different 3D images. In the system, light sources are preferably LEDs or organic LEDs and scanners are preferably made from polymer or silicon materials.

Another preferable scanning mode can be in-plane mode but in this mode the imaging lens will not be connected to the scanning platform. The module will scan behind a motionless lens and according to scanner's relative position to the lens; the ray bundles emitted from the light sources on the scanner will be directed to different screen pixels.

In a further advantageous implementation, the light sources can be motionless and the lens is scanned in in-plane mode in front of the light sources to image them to different screen pixels.

Different actuation mechanisms such as electrostatic or electromagnetic actuation can be used for realizing the scanning. In a preferred system, electromagnetic actuation with a magnet placed on top of the scanner interacts with an external electro coil driven with alternating current. In a further preferred system, the electro coil can be printed or fabricated on to the scanner and actuation can be realized by an external magnet.

In another implementation of the system, instead of using 1D array of light sources per each main color coupled with 1D scanner, a single light source per each main color coupled with 2D scanners is used. Here the light source can be preferably laser diodes, vertical cavity surface emitting diodes (VCSELs). Scanners are preferably made from polymer or silicon materials or from both of them. The light sources can be on top of the scanners or they can be external and their light can be reflected to the screen pixels by a mirror placed on top of the 2D scanners.

In all configurations, the scanning angle of the scanners can be limited to a specific narrow angle with a specific offset if only limited numbers of viewers are viewing the display from a limited viewing angle. This embodiment of the system is quiet advantageous as it will increase the efficiency and as a result brightness of the display.

In another system, a special screen that can move left and right directions according to the position of the viewers constituted from an array of cylindrical lenses that have modulatable pitch sizes can be used together with a head tracking system to send 3D information only to the specific region where viewers are standing. This system can be preferably used with personal devices. This special screen can be used either in front of displays having light sources located at the pixel positions including liquid crystal displays (LCD) or displays that have pixels scanned with at least one scanner coupled with at least one light source in a certain depth.

### BRIEF DESCRIPTION OF THE DRAWINGS

FIG. 1—The working principle of the quasi-holographic volumetric display

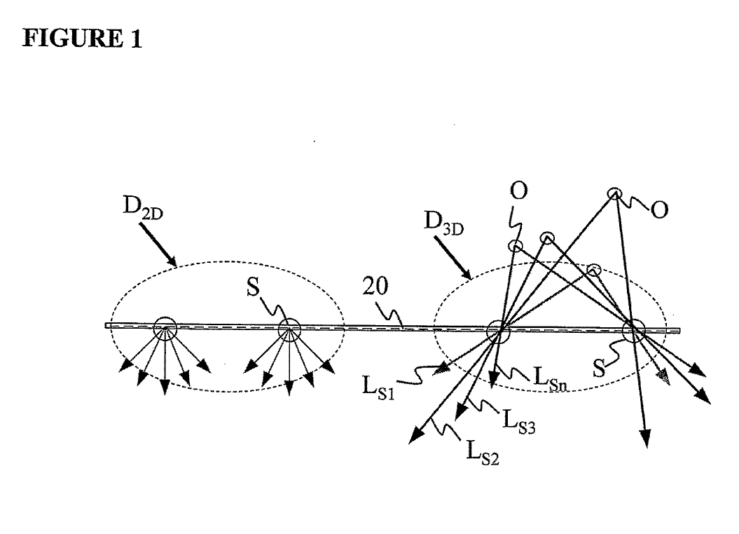

FIG. 2—The basic unit of the Holografika display

FIG. 3—Different viewers looking from different perspectives receive different views

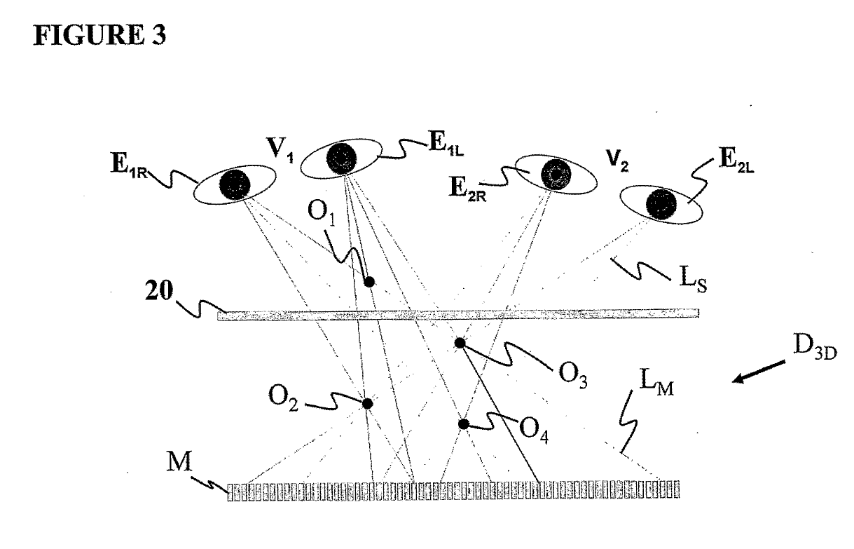

FIG. 4—(a) 1D LED arrays in RGB colors and driver IC mounted on FR4 scanner platform; (b) Scanner modules as the basic unit of the 3D display.

FIG. 5—Every pixel on the screen is illuminated by different modules whose number is equal to the number of different emission directions from the pixel

FIG. 6—Voxels rendered (i) in front of the screen, (ii) between the screen and the LED modules, (iii) behind the LED modules.

FIG. 7—The optical behavior of the system in vertical and horizontal directions.

FIG. 8—Micro lens array in superposition mode to image the light sources onto the screen

FIG. 9—Micro lens array in apposition mode to image the light sources onto the screen

FIG. 10—3D display scanning modules implementation with lateral translations of a lens

FIG. 11—FPGA as a LED Driver on polymer scanner for driving the LED array

FIG. 12—The complete display

FIG. 13—2D Scanning Based 3D Display Concept using laser diodes placed on top of polymer scanners

FIG. 14—2D Scanning Based 3D Display Concept using mirrors placed on top of polymer scanners illuminated by external laser diode sources

FIG. 15—In the display concept there is an array of 2D polymer/hybrid scanners in the horizontal axis of the display

FIG. 16—Vertical and Horizontal view of the display

FIG. 17—Back and Forth Movement of the Pitch-Size Modulatable Lenticular Screen

FIG. 18—Left and Right Movement of the Pitch-Size Modulatable Lenticular Screen

### DETAILED DESCRIPTION OF EMBODIMENTS

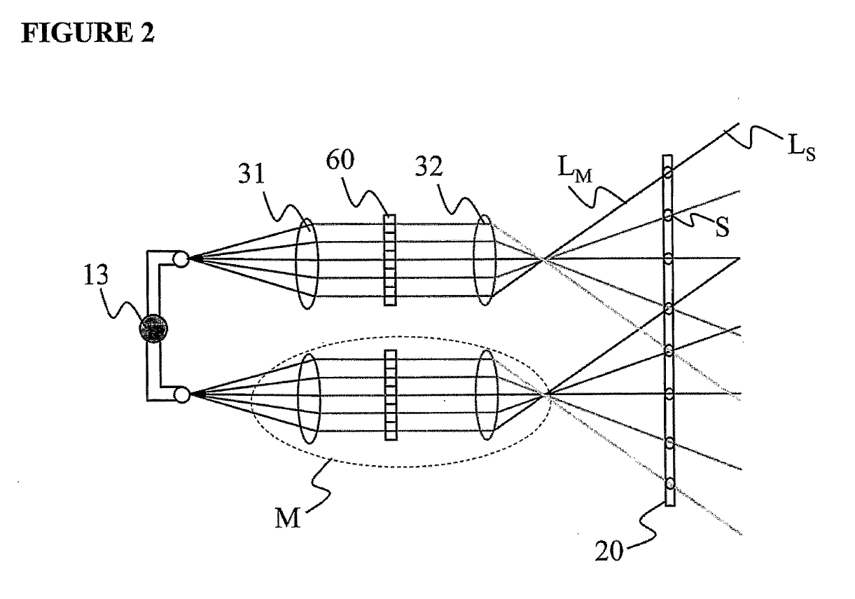

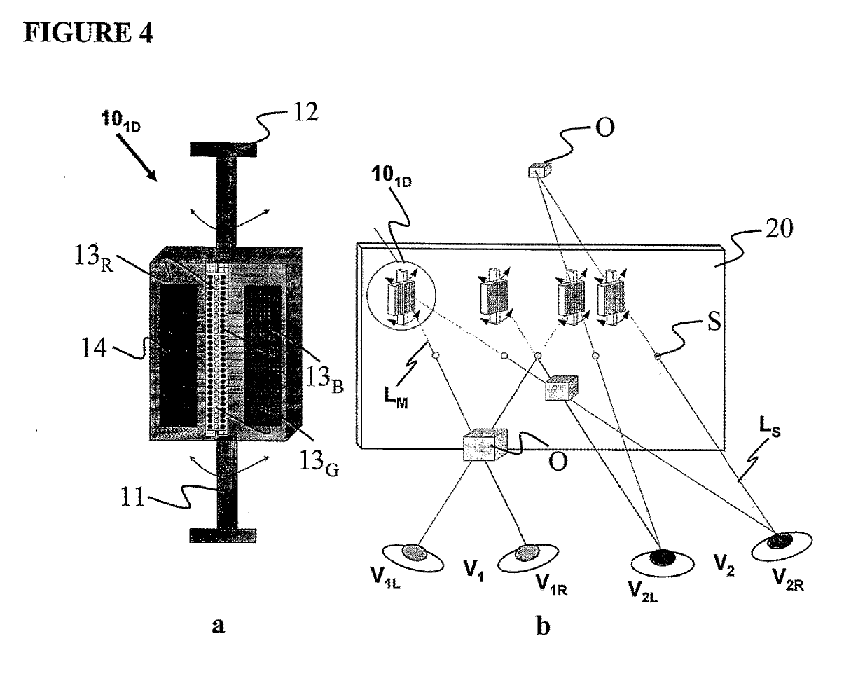

The light source 13, collimator 31, 2D micro display panels 60, and the lens system 32 in front of the micro display 60 in FIG. 2 mentioned above are replaced with a one-dimensional (1D) scanning module 10_{1D} coupled with at least one light source 13 per each color and an imaging lens 30 in front. In a preferred embodiment, 1D LED array per color (13_{R}, 13_{G} and 13_{B}) is integrated onto the 1D scanning module 10_{1D} as the light source 13 of the system. A one-dimensional (1D) LED array per color 13 and the LED driver IC 14 integrated on a 1D scanning module 10_{1D} can be seen in FIG. 4(a), which constitutes the basic functional unit of the display system. In a preferred embodiment, the scanner 10_{1D} is made on FR4 substrate, a fiber-glass epoxy composite, using standard PCB technology [7] and scans in torsional mode via the flexible members 11 of the 1D scanning module 10_{1D} that are connected to a fixed platform 12. Depending on the number of LEDs per 1D scanning module 10_{1D}, the driver IC 14 can be mounted ON or OFF the moving platform. 2D array of such 1D scanning modules 10_{1D} are tiled behind a special screen 20 for full system operation [8].

Each 1D scanning module 10_{1D} creates a horizontal scan line by way of electromagnetic actuation in this preferred embodiment [9]. A magnet is placed onto the backside of the 1D scanning module 10_{1D} and modulated by an external electrocoil. In order to realize the screen 20 capable of emitting different color and intensity light to different directions from its pixels S, red, green, and blue LEDs, 13_{R}, 13_{G} and 13_{B} are modulated individually during scan and the images for each color LED can be overlapped in space by introducing slight time-shifts in between R, G, B LED drive signals during the scan.

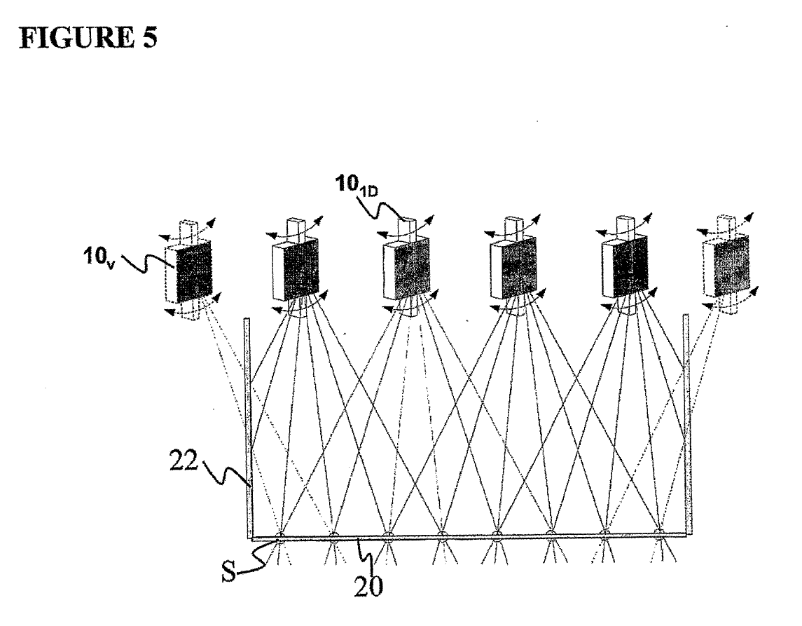

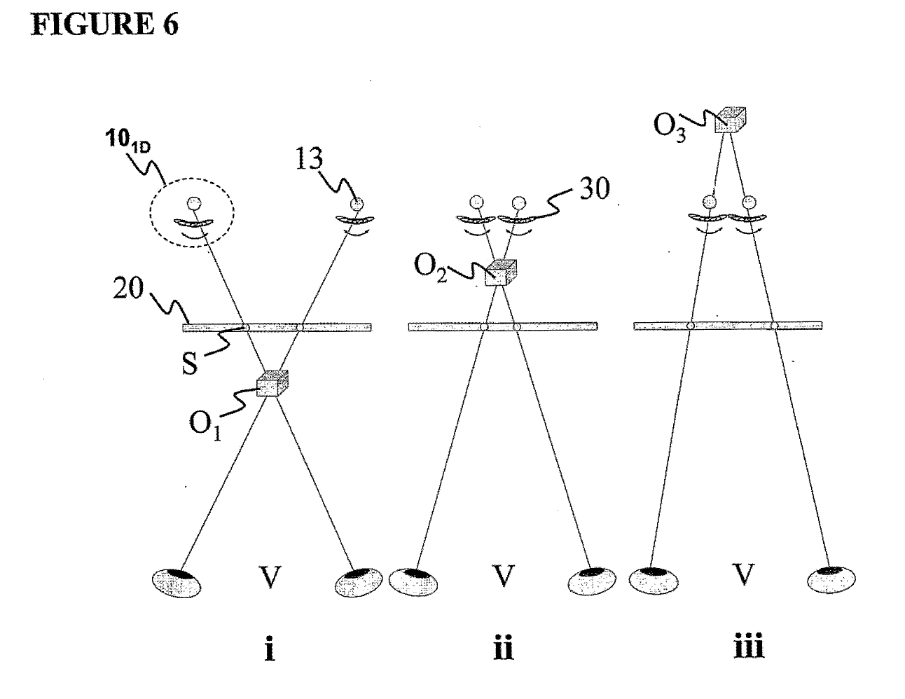

As illustrated in FIG. 4(b), each 1D scanning module 10_{1D} address an array of screen pixels S on the special screen 20 and provide independently modulated light beams L_{M} with different angles for each screen pixel S. Screen pixels S are illuminated by a number of such 1D scanning modules 10_{1D} with independently modulated light beams L_{M} with different ray angles. The number of emission directions for each screen pixel S is equal to the number of 1D scanning modules 10_{1D} illuminating the screen pixel S. Placing mirrors 22 at the sides of the display would create virtual modules 10_{V} and create the missing illumination directions Lₛ for the screen pixels S near the edge of the display as illustrated in FIG. 5. A virtual source point or voxel O is perceived at the intersection of two properly modulated ray bundles received by the left and right eyes of a viewer. The precisely controlled intersections of rays coming from several scanning units 10_{1D} correspond to a complete set of voxels O and the two viewers V₁, V₂ looking from different perspectives will see different 3D images as shown in FIG. 4. As illustrated in FIG. 6, voxels O can be rendered at different depths. In FIG. 6(i), O₁ is rendered in front of the screen 20; in FIG. 6(ii), O₂ is rendered between the screen 20 and 1D scanning modules 10_{1D}; and in FIG. 6(iii), O₃ is rendered behind the modules 10_{1D}. Note that the viewer's focus and vergence are in coordination and different for each voxel O depth, eliminating the binocular rivalry.

The screen 20 is capable of diffusing light into a narrow angle in the horizontal direction and into a wide angle in the vertical direction—i.e., elliptically diffusing screen 20. A narrow angle is required in the horizontal direction as each screen pixel S on the display should emit light with different color and intensity to separate horizontal directions without any crosstalk between neighboring directions. The wide angle in the vertical direction is required as the display is designed to provide motion parallax only in the horizontal direction (i.e., the same image is received by the viewer at the same horizontal position and different vertical positions of the eye pupils.)

The number of different views for the display is the same with the number of independently controllable horizontal emission directions from the screen pixels S. In a preferred embodiment, there are 40 different views using 1° divergence for each emission direction and 40° scan angle. The resolution of the display can be calculated using the following relationship:

$$\begin{matrix}{N}_{H} = \frac{{n}_{h} \times p}{r} & ( 1 ) \\ {N}_{V} = {n}_{v} \times l & ( 2 )\end{matrix}$$

N_{H}, Nᵥ: number of screen pixels S in the horizontal and vertical directions,
nₕ, nᵥ: number of 1D scanning modules 10_{1D} in the horizontal and vertical directions,
p: number of horizontal screen pixels S addressed by each 1D scanning module 10_{1D}
r: number of different ray directions through each screen pixel S
l: number of LED color triads on a line in each 1D scanning module 10_{1D}

The number of voxels O (N_{T}) fed into the data channel per frame in the 3D display system is given by the product of total number of LEDs and p:

N_{T}=nₕnᵥlp (3a)

Equivalently, number of voxels O (N_{T}) can also be calculated using the total number of screen pixels S and ray directions:

N_{T}=NₕNᵥr (3b)

Table 1 provides an exemplary system design parameters for 2 million and 20 million voxels O with different display depths.

TABLE 1
Examplary system design parameters for 2 Million and 20 Million
voxels in 3D space for two systems with different sizes.

| Voxels | 2 × 10⁶ | 2 × 10⁶ | 20 × 10⁶ | 20 × 10⁶ |
|---|---|---|---|---|
| N_{H} | 240 | 240 | 720 | 720 |
| Nᵥ | 160 | 160 | 576 | 576 |
| nₕ | 80 | 48 | 240 | 144 |
| nᵥ | 5 | 5 | 18 | 18 |
| P | 150 | 250 | 150 | 250 |
| l | 32 | 32 | 32 | 32 |
| r | 50 | 50 | 50 | 50 |
| FOV | 50 | 50 | 50 | 50 |
| Display | 160 | 268 | 160 | 268 |
| Thickness | mm | mm | mm | mm |

The table implies that the resolution of the system can be increased by increasing the number of 1D scanning modules 10_{1D} without altering the 1D scanning module 10_{1D} design or the screen 20 depth, resulting in a scalable architecture. Another implication of the table is that the screen 20 depth can be reduced by reducing p and increasing nₕ.

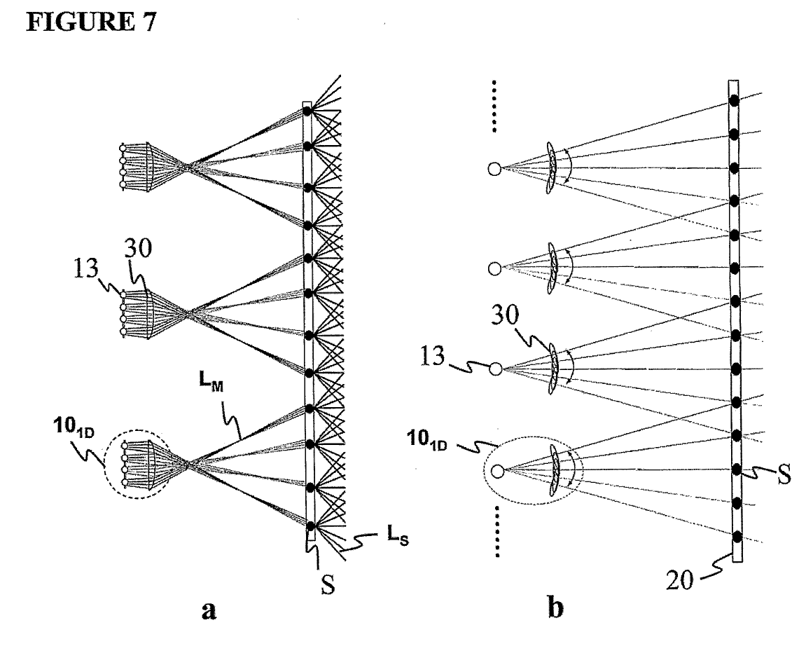

The optics for the system is rather simple and illustrated in FIG. 7. Each 1D scanning module 10_{1D} has an imaging lens 30 that rotates together with the module 10_{1D} and provides imaging of LEDs onto the screen 20 with some magnification. The imaging lens 30 can be either refractive or diffractive. The focal length of the lenses 30 and the distance of the lenses 30 to the LEDs 13 are determined by the distance of the screen 20 to the 1D scanning modules 10_{1D} and the emission area of the LEDs 13. The vertical cross section of the display as illustrated in FIG. 7(a) shows an array of 1D LED arrays 13 and the horizontal cross section as illustrated in FIG. 7(b) shows an array of single LEDs 13. Each LED 13 on a module 10_{1D} provides illumination to a fraction of one row of the screen 20 in a light efficient manner by turning the LED 13 ON only while traversing a screen pixel S. The vertical resolution is increased by tiling 1D scanning modules 10_{1D} in the vertical axis and number of ray angles from each screen pixel S is increased by tiling 1D scanning modules 10_{1D} in the horizontal axis.

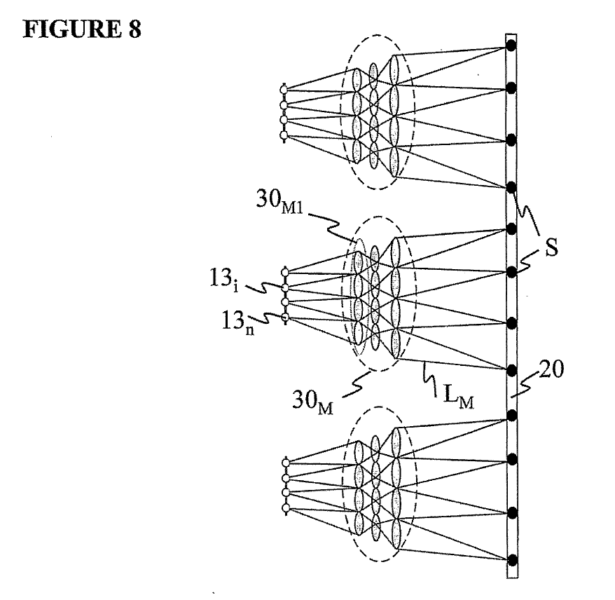

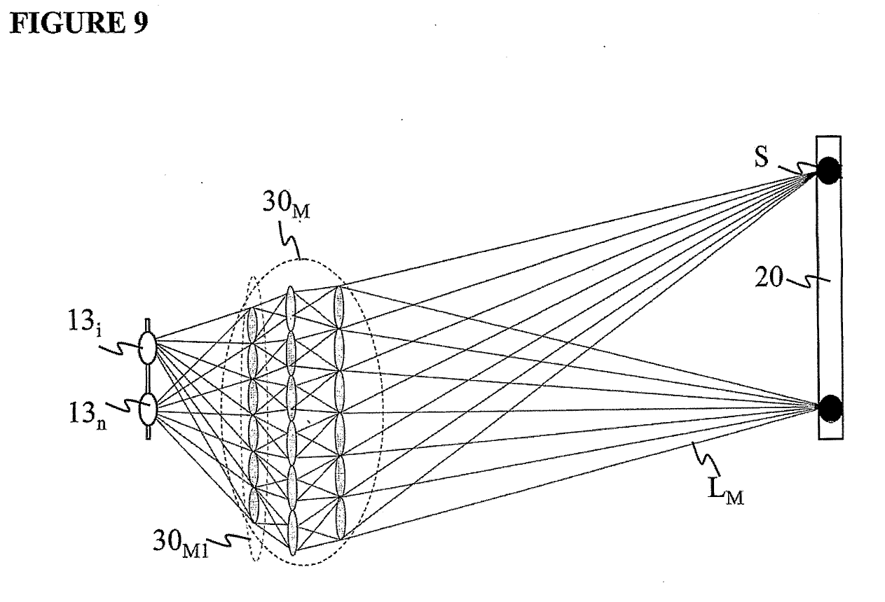

Plurality of microlens arrays 30_{M} can also be used as the imaging lens 30 in front of each 1D scanning module 10_{1D}. There are different modes of microlens arrays that can be used to image the light sources 13 to the screen 20. The first mode is superposition mode as illustrated in FIG. 8. In this mode all the microlenses of the first microlens array 30_{M1} collect light from all individual light sources 13ᵢ-13ₙ and plurality of micro lens arrays 30_{M} image them onto the screen 20. In the second mode as shown in FIG. 9, light emitted from each light source 13ᵢ-13ₙ is collected by a specific micro lens in the first micro lens array 30_{M1} and each light source 13ᵢ-13ₙ is imaged separately from separate microlenses.

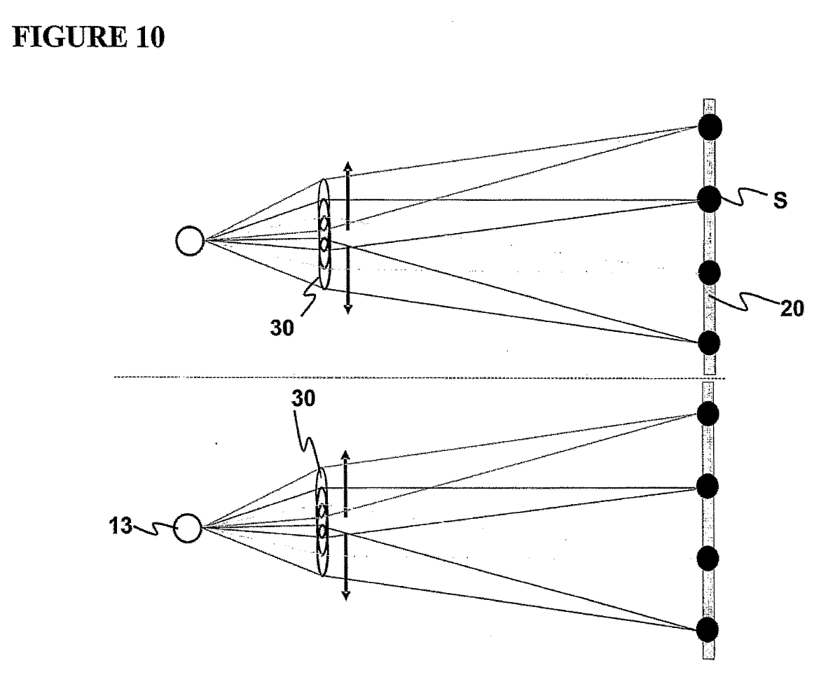

As can be seen in FIG. 10, the same 3D Display concept in horizontal direction can be realized by an imaging lens 30 in front of the light source 13, preferably LED array, that is not connected to the 1D scanning module 10_{1D} and moving continuously in the lateral direction with a speed and rate determined by the display requirements (the number of spreading angles from each module). In this configuration, the lens 30 scans instead of the LED array integrated 1D scanning module 10_{1D}. This configuration also seems to be easy to implement. However aberrations can give rise to quality problems in lens 30 moving system due to light bundles imaged from lens 30 edges.

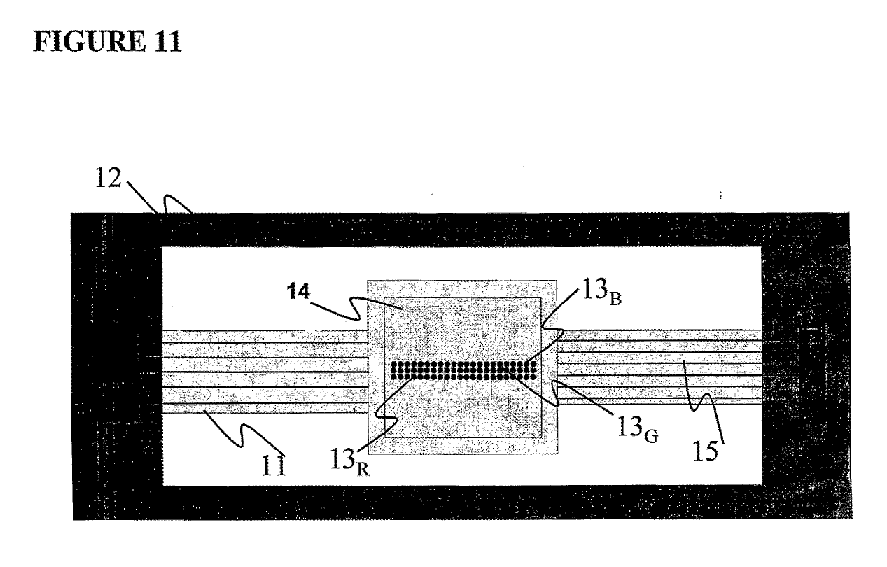

The LED arrays will be driven with a LED driving IC 14 which will also be placed on top of the polymer 1D scanning platform 10_{1D} to produce a compact system with minimum electrical connections through the flexible members 11 of the 1D scanning module 10_{1D} that are connected to a fixed platform 12. The second way of LED driving will be using an external LED driving circuitry with a field programmable gate array (FPGA), complex programmable logic device (CPLD) or an ASIC. Placing the LED driving IC 14 on top of the 1D scanning platform 10_{1D} provides a more compact design and gives the opportunity of increasing the number of LEDs on a single FR4 scanner as fewer electrical signals 15 should be carried through the flexible members 11 of the 1D scanning module 10_{1D}. These signals 15 would be limited, in the case of an FPGA, with the FPGA supply voltages V_{CCO}, V_{CCAUX} and V_{CCINT}, JTAG programming interface signals, 1 bit clock signal and 1 bit serial input data that would modulate the LEDS connected to the FPGA I/O pins. In this case, the number of the LEDs that can be driven will be limited with the number of I/O pins of the FPGA which can be quite high; more than four hundred with an I/O optimized FPGA as shown in FIG. 11.

The LEDs are driven by pulse width modulation (PWM) method. N bit depth level PWM provides 2^{N} different intensity levels. A counter is synthesized within FPGA whose output value is compared with a reference value for each single output pin and produces PWM LED drive signal. N-bit video input determines the LED drive pulse width.

The input video data frequency at which the data will be fed into the FPGA will be:

$${f}_{V} = \frac{3 l n 2 {pf}_{D} {d}_{PWM}}{{d}_{w}} \qquad ( 4 )$$

fᵥ: the frequency of the input video data
l: number of LEDs per color on a line on each 1D scanning module 10_{1D}
n: the number of 1D scanning modules 10_{1D} driven with the same driver
p: number of horizontal screen pixels S addressed by each 1D scanning module 10_{1D}
f_{D}: display refresh rate
d_{PWM}: PWM bit depth
d_{W}: input video data line width

As an example, assume f_{D}=60 Hz scan frequency—typical refresh rates of displays and l=30 (or 90 LEDs per module), d_{PWM}=10-bit, n=1 (scanners controlled by each driver), p=100 pixels/LED (=200 modulations per cycle due to bidirectional scanning). In such a case, if 1 bit per color (d_{W}=3) serial input video data is fed into the FPGA then 3.6 MHz clock frequency would be required. Taking into account the sinusoidal speed variation of the scanner during resonant operation, this average data rate need to vary by about a factor of 2 from the center to the edge of the scan line.

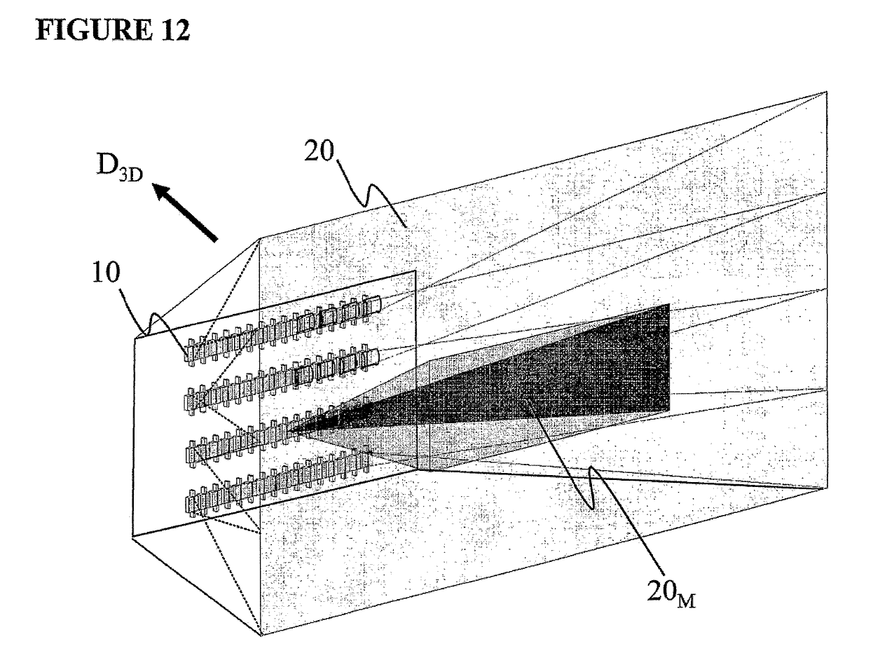

The whole display concept D_{3D} is shown in FIG. 12. There is 2D array of 1D integrated polymer 1D scanning modules 10_{1D} behind the special screen 20 elliptically diffusing the light coming from the LEDs. Each module 10_{1D} illuminates a specific portion 20_{M} of the screen 20 as illustrated in FIG. 12.

In the case of limited number of viewers, viewing the display from a limited field of view (FOV), the scanning angle of the scanners can be limited to a specific narrow angle with an offset angle enough to feed all the viewers in the limited FOV. Each actuated 1D scanning module 10_{1D}—electromagnetically in the above configuration—is applied a certain constant magnetic force according to the viewers' position in the FOV of the display. The 1D scanning modules 10_{1D} are scanned with an alternating magnetic force around this offset value to provide the left and right eye views simultaneously for the limited number of viewers. By this way, the display system D_{3D} works more efficiently and the display will be brighter as the number of views is limited.

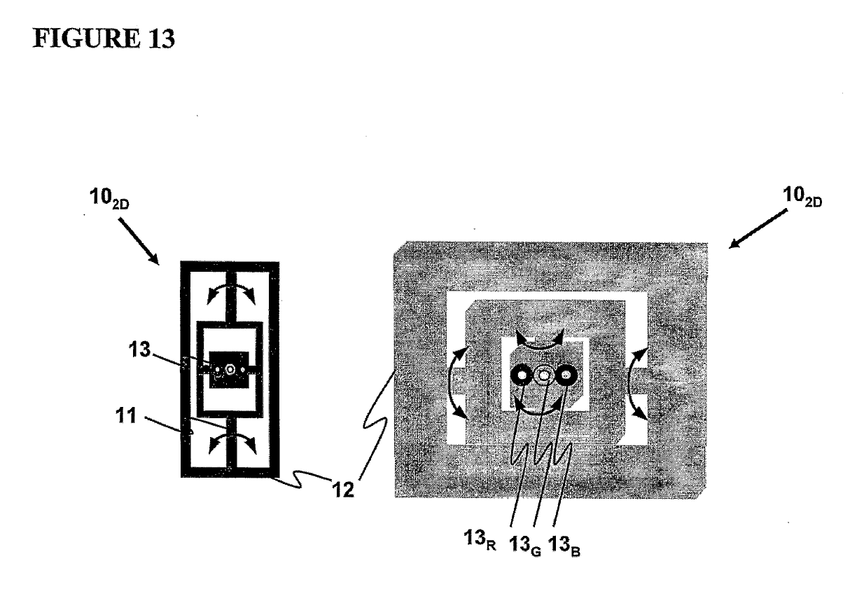

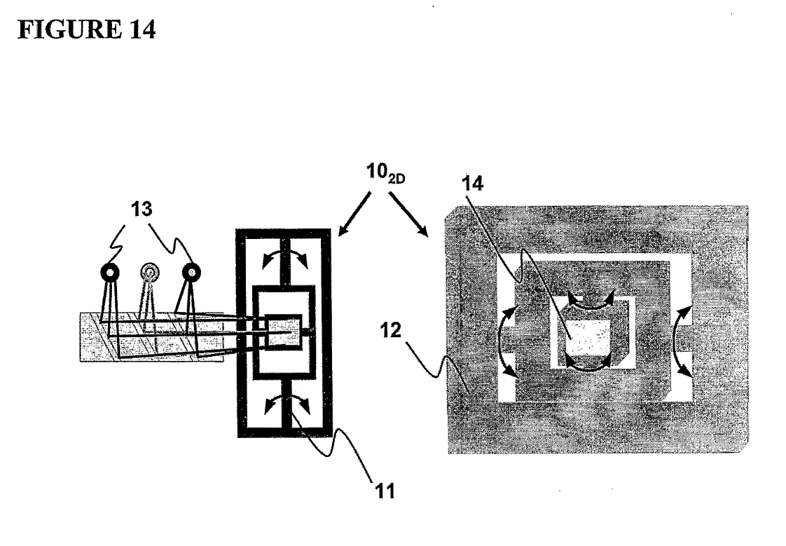

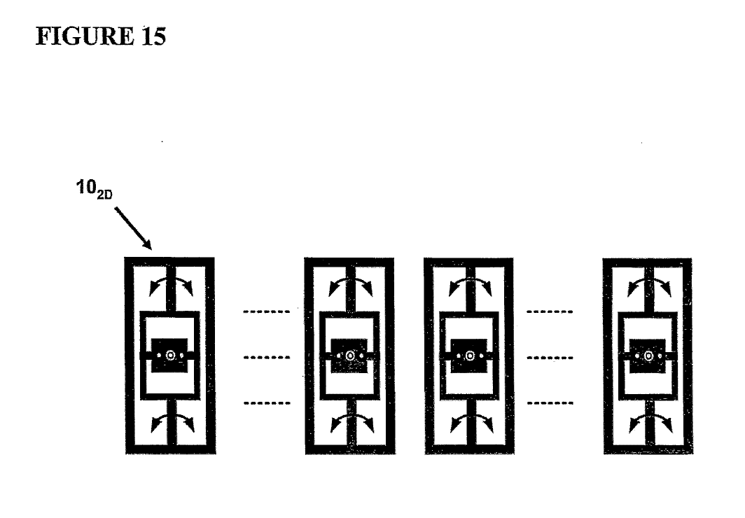

The above 3D display concept D_{3D} can also be realized by using single laser diode or vertical cavity surface emitting laser (VCSEL) for each red, green and blue colors as the light source 13 of the display scanned with 2D scanning modules 10_{2D} instead of the 1D LED array for each red, green and blue colors scanned with 1D scanning modules 10_{1D}. Two different configurations can be designed for the system using 2D scanning. In the first configuration, the laser light sources 13_{R}, 13_{G}, 13_{B} are placed on top of the 2D scanning modules 10_{2D} as shown in FIG. 13 similar to the 1D LED array placed on top of the 1D polymer scanners 10_{1D}. In FIG. 13, the light sources 13_{R}, 13_{G}, 13_{B} are placed in the horizontal direction; however they can be also placed in the vertical direction. In the second configuration, mirrors 14 are placed on top of the 2D scanning modules 10_{2D} and 2D scans the light emitted by external laser diodes/VCSELs 13 as illustrated in FIG. 14. The 2D scanning modules 10_{2D} scan via the flexible members 11 that are connected to the fixed platform 12 as illustrated in FIG. 13 and FIG. 14. In the system, there is 1D array of 2D scanning modules 10_{2D} in horizontal direction as shown in FIG. 15. Similar to the 1D array configuration that is illustrated in FIG. 10, the light sources 13 can be kept still and the imaging lens 30 in front of the light sources 13 can be actuated in 2D to image the light sources 13 on to the screen pixels S.

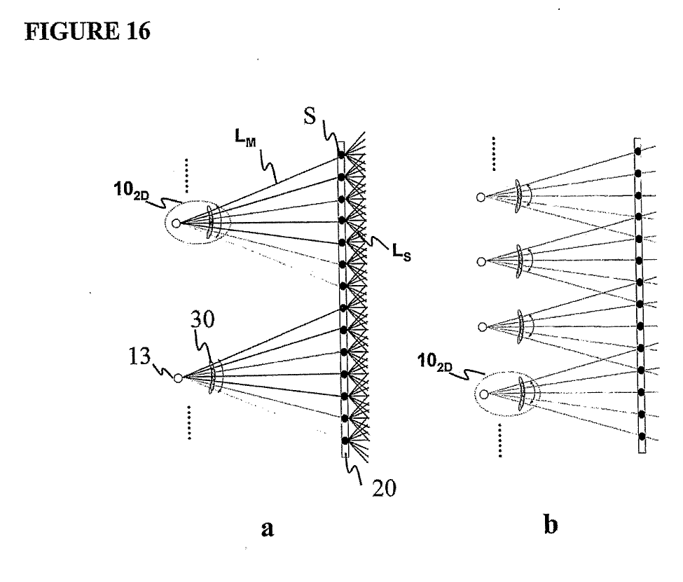

The horizontal resolution calculation of the system is the same with the above 3D system. The only difference appears in the vertical resolution calculation. The vertical resolution is the number of the vertical screen pixels S addressed by each scanning module 10_{2D}. The optics for the system is simple, only an imaging lens 30 for each 2D scanning module 10_{2D} is required. The horizontal and the vertical cross section of the system can be seen in FIGS. 16(a) and 16(b) respectively. Both the vertical and the horizontal cross sections of the display show an array of 2D scanning modules 10_{2D}. Each light source 13 on a single 2D scanning module 10_{2D} provides illumination to an area enclosing all the screen pixels S on a fraction of the screen 20_{M}. The number of 2D scanning modules 10_{2D} in vertical direction is determined by the scanning requirements of each 2D scanning modules 10_{2D} in the vertical direction.

Similar to the 1D scanning module 10_{1D} with 1D light source array, 2D scanning module 10_{2D} can also work with a constant force and actuate around a specific angle only to feed a limited number of viewers in a limited FOV. Similar to the 1D case, scanning in a narrower angle increases the efficiency of the system and brighter images the viewers receive.

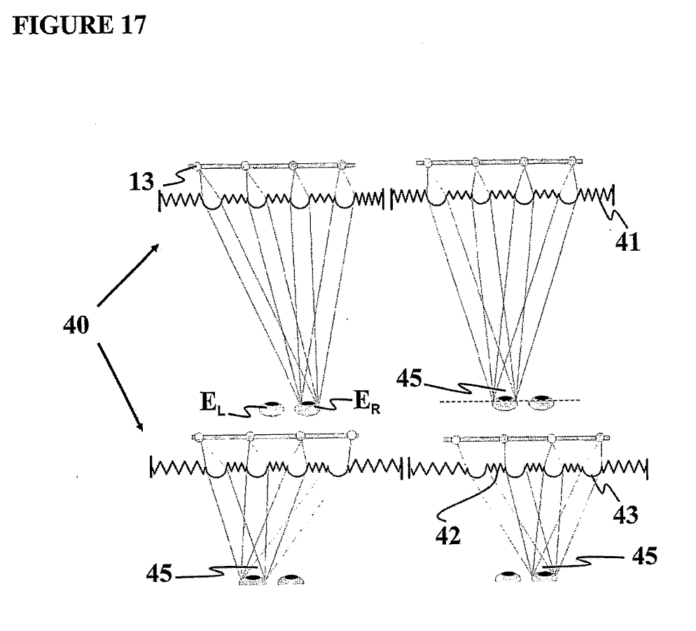

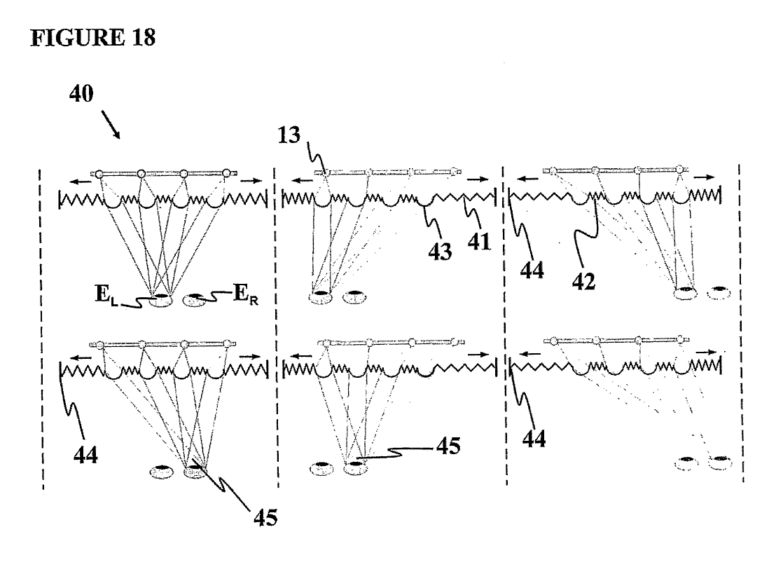

A single viewer 3D display more appropriate for personal devices using scanning light concept can be realized by using a dynamic screen 40—e.g. an array of cylindrical lenses (lenticular sheet) in front of the light sources 13 as shown in FIGS. 17 and 18. The dynamic screen 40 has an array of pitch size modulatable microlenses 43. According to the viewer's V distance to the screen—exit pupil 45 distance to the screen, the pitch sizes of the pitch size modulatable microlenses 43 can be increased or decreased as shown in FIG. 17 via flexible members connecting micro lenses 42. In a preferred embodiment, this functionality can be realized by using piezoelectric materials for the flexible members connecting micro lenses 42. The dynamic screen 40 is also capable of moving left and right with constant lens pitch sizes by flexible members 41 connected to fixed frame 44 to follow the viewer's movement—exit pupil 45 movement to the left and the right direction for a specific viewing distance to the screen 40. The concept is illustrated in FIG. 18. For a specific position of the viewer in FOV of the display, the screen 40 changes its position successively in two different appropriate positions for providing the left and right eye views of the viewer as shown in FIG. 17 and FIG. 18.

### REFERENCES

[1 ] P. Benzie, J. Watson, P. Surman, I. Rakkolainen, K. Hopf, H. Urey, V. Sainov, C. Von Kopylow, “A survey of 3DTV Displays, Techniques and Technologies”, IEEE Transactions on Circuits and Systems for Video Technology, vol. 17, no. 11, November 2007
[2 ] J. Y. Son, B. Javidi, “Three Dimensional Imaging Methods Based on Multiview Images”, IEEE Journal of Display Technology, vol. 1, no. 1, pp. 125-140, September 2005
[3] T. Balogh, Method and Apparatus for Displaying 3D Images, U.S. Pat. No. 6,999,071, 14 Feb. 2006
[4] T. Balogh, T. Forgacs, T. Agocs, O. Balet, E. Bouvier, F. Bettio, E. Gobbetti, G. Zanetti, “A Scalable Hardware and Software System for the Holographic Display of Interactive Graphics Applications”, Eurographics 2005
[5] Y. Takaki, “High-Density Directional Display for Generating Natural Three-Dimensional Images,” Proc. of the IEEE, vol. 94, no. 3, pp. 654-663, 2006.
[6]Y. Kajiki, H. Yoshikowa, T. Honda, “Auto Streoscopic 3-D Video Display Using Multiple Light Beams with Scanning”, IEEE Transactions on Circuits and Systems for Video Technology, Vol. 10, No. 2, March 2000
[7]H. Urey, S. Holmstrom, A. D. Yalcinkaya, “Electro magnetically actuated FR4 Scanners,” Phot. Tech. Lett., Vol. 20, p. 30-32, 2008
[8] M. Sayinta, H. Urey, “Scanning LED Array Based Volumetric Display”, IEEE 3DTV-CON, Kos Island 2007
[9] Serhan O. Isikman, Olgac Ergeneman, Arda D. Yalcinkaya, Hakan Urey, “Modeling and Characterization of Soft Magnetic Film Actuated 2D Scanners,” J. Selected Topics in Quantum Electronics, Vol. 12, pp. 283-289, March/April 2007

What is claimed is:

1) An apparatus for displaying 3D images comprising
A screen 20;
3D video electronics;
Plurality of 1D scanning platforms 10_{1D};
At least one light source 13 coupled with each scanning platform 10_{1D};
Imaging optics coupled with each scanning platform 10_{1D}.

2) The apparatus of claim 1 wherein the at least one light source 13 is laser, OLED, or LED.

3) The apparatus of claim 1 further comprising an imaging lens 30 mounted to the scanning platform 10_{1D}.

4) The apparatus of claim 1 wherein the imaging lens 30 is refractive lens, diffractive lens, or a compound eye formed with plurality of microlens arrays 30_{M} or plurality of reflectors.

5) The apparatus of claim 1 further comprising driver electronics 14 for the at least one light source 13 mounted to the scanning platform 10_{1D}.

6) The apparatus of claim 1 wherein the scanning platform 10_{1D} comprise an actuating mechanism to produce an angular displacement for the scanning platform 10_{1D} to project light from the at least one light source 13 in different directions based on the angular displacement of the scanning platform 10_{1D}.

7) The apparatus of claim 1 wherein the scanning platform 10_{1D} comprise a polymer or silicon material.

8) The apparatus of claim 1 wherein the scanning platform 10_{1D} is connected to a fixed platform 12 via at least one flexible member 11.

9) The apparatus of claim 1 wherein at least one flexible membrane 11 includes at least one metal trace to provide electrical connectivity to the at least one light source 13.

10) The apparatus of claim 1 wherein the at least one light source 13 is fabricated on the scanning platform 10_{1D}.

11) The apparatus of claim 1 wherein each scanning module 10_{1D} is rotated with a different DC bias to provide higher brightness 3D image to fewer viewers than the more general case of scanning large angles.

12) The scanning platform 10_{1D} of claim 6 wherein the at least one light source 13 and the coupled drive electronics 14 are integrated with the scanning platform 10_{1D}.

13) A scanning platform 10_{1D} as claimed in claim 1, wherein the scanning platform 10_{1D} is driven to oscillate at the video frame rate of about 60 Hz.

14) An apparatus for displaying 3D images comprising
A screen 20;
3D video electronics;
Plurality of 2D scanners 10_{2D};
At least one light source 13 coupled with each scanner 10_{2D};
Imaging optics coupled with each scanner 10_{2D}.

15) The apparatus of claim 14 wherein the 2D scanning is obtained by rotation of a two 1D scanner 10_{1D} or one 2D scanner 10_{2D}.

16) The apparatus of claim 14 wherein the 2D scanning is obtained by 2D translations of a lens 30 or the at least one light source 13 relative to each other in a plane substantially perpendicular to the light emission direction of the at least one light source 13.

17) The apparatus of claim 14 wherein the 2D scanning is obtained by 2D translations of at least one microlens array 30_{M} or the at least one light source 13 relative to each other in the a plane substantially perpendicular to the light emission direction of the at least one light source 13.

18) The apparatus of claim 14 wherein the at least one light source 13 is laser, OLED, or LED.

19) The apparatus of claim 14 further comprising an imaging lens 30 mounted to the scanning platform 10_{2D}.

20) The apparatus of claim 14 wherein the imaging lens 30 is refractive lens, diffractive lens, or a compound eye formed with plurality of microlens arrays 30_{M} or plurality of reflectors.

21) The apparatus of claim 14 further comprising driver electronics for the at least one light source 13 mounted to the scanning platform 10_{2D}.

22) The apparatus of claim 14 wherein the scanning platform 10_{2D} comprise an actuating mechanism to produce an angular displacement for the scanning platform 10_{2D} to project light from the at least one light source 13 in different directions based on the angular displacement of the scanning platform 10_{2D}.

23) The apparatus of claim 14 wherein the scanning platform 10_{2D} comprise a polymer or silicon material.

24) The apparatus of claim 14 wherein the scanning platform 10_{2D} is connected to a fixed platform 12 via at least one flexible member 11.

25) The apparatus of claim 14 wherein at least one flexible membrane 11 includes at least one metal trace to provide electrical connectivity to the at least one light source 13.

26) The apparatus of claim 14 wherein the at least one light source 13 is fabricated directly on the scanning platform 10_{2D}.

27) The apparatus of claim 14 wherein each scanning module 10_{2D} is rotated with a different DC bias to provide higher brightness 3D image to fewer viewers than the more general case of scanning large angles.

28) The scanning platform of claim 22 wherein the at least one light source 13 and the coupled drive electronics 14 are integrated with the scanning platform 10_{2D}.

29) An apparatus for displaying 3D images and adjusting the exit pupil 45 locations comprising;
An array of light generating elements 13 at pixel S locations;
3D video electronics;
A dynamic screen 40 to generate different light emitting directions from each pixel S controlled by the 3D video electronics;
An actuator coupled with the dynamic screen 40.

30) The apparatus of claim 29 wherein the light sources 13 are LEDs, organic LEDs, fluorescent screen, or LCD panel with backlight.

31) The apparatus of claim 29 wherein the lenticular screen comprising at least one flexible member 41 connected to an actuator to change the pitch of the lenticulars to affect the screen 40 to exit pupil 45 or viewing zone distance for the 3D viewing positions.

32) The apparatus of claim 29 wherein the lenticular screen comprising at least one flexible member 41 connected to an actuator to change the lateral position of the lenticulars to affect the exit pupil 45 or viewing zone locations.

33) The apparatus of claim 29 wherein the actuator comprising a piezoelectric, electrostatic, or electromagnetic means to generate the actuation force.

34) The dynamic lens screen of claimed 29 wherein the actuator is driven to oscillate at the video frame rate multiplied by the number of desired 3D views.
